(19) United States
(12) Patent Application Publication
(10) Pub. No.: US 2025/0191819 A1
(43) Pub. Date: Jun. 12, 2025

(54) FINE GRAIN STRUCTURES FOR TOUGH RARE EARTH PERMANENT MAGNETS

(71) Applicant: Iowa State University Research Foundation, Inc., Ames, IA (US)

(72) Inventors: Baozhi Cui, Ames, IA (US); Jun Cui, Ames, IA (US)

(21) Appl. No.: 19/039,825

(22) Filed: Jan. 29, 2025

Related U.S. Application Data
(62) Division of application No. 16/974,145, filed on Oct. 19, 2020, now Pat. No. 12,272,471.
(60) Provisional application No. 62/974,009, filed on Nov. 6, 2019.

(51) Int. Cl. H01F 1/055; H01F 1/058; H01F 1/059; H01F 7/02; H01F 41/02

(52) U.S. Cl. CPC H01F 1/0557; H01F 1/058; H01F 1/059; H01F 7/02; H01F 41/0253

(57) ABSTRACT

The present invention provides fine grain structures for rare earth permanent magnets (REPMs) and their production in a manner to significantly enhance flexural strength and fracture toughness of the magnets with no or little sacrifice in the hard magnetic properties. The tough REPMs can have either homogeneous or heterogeneous refined grain microstructural architectures achieved by introducing a small amount of additive particle materials into the magnet matrix, such as fine-sized, insoluble, chemically stable, and non-reactive with the magnet matrix. These additive materials can act effectively as both heterogeneous nuclei sites and grain growth inhibitors during the heat treatment processes, which in turn resulting in refined grain structures of the REPMs. Alternatively, the fine grain structures were also achieved by using magnet alloy feedstock powders with finer particle sizes. The fine grains acting as the strengthening sites can inhibit the crack nucleation and can also slow down the propagation of micro-cracks, which in turn increasing magnet's fracture toughness.

### CONTRACTUAL ORIGIN OF THE INVENTION

This invention was made with government support under Contract No. DE AC02-07CH11358 awarded by the U.S. Department of Energy. The government has certain rights in the invention.

### FIELD OF THE INVENTION

The present invention relates generally to rare earth permanent magnets (REPMs) made by introducing a small amount of additive particle materials into the magnet matrix or by using fine powder precursors with beneficial refined grain structures as well as to magnet production methods. More particularly, the invention relates to fine grain structures for REPMs that significantly enhance flexural strength and fracture toughness of the magnets with no or little sacrifice in hard magnetic properties.

### BACKGROUND OF THE INVENTION

Rare-earth permanent magnets (REPMs) mainly include R-cobalt type (mainly including RCo₅ and R₂Co₁₇ types, R=rare earth, Lanthanum, or Yttrium) magnets, R-iron-boron type (R₂Fe₁₄B type or R—TM—B, TM is selected from a group of transition metals consisting but not limited to Fe, Co and other transition metal elements) magnets, a R—TM-carbon type magnet (R₂Fe₁₄C type), a R—TM-nitrogen type magnet (R₂Fe₁₇X_{δ}type, R=rare earth, La, or Y; X=H, C, N, B, F, P, and/or S), or a R—TM—M-nitrogen type magnet (R(Fe, M)₁₂X_{δ}type, R=rare earth, La, or Y; M=Mo, V, Ti, Si, Al, Cr, Cu, Ga, Ge, Mn, Nb, Sn, Ta, W or Fe; X=H, C, N, B, F, P, and/or S), and some other stable or metastable rare-earth-transition metal based magnetic compounds. Sm—Co and Nd—Fe—B based sintered magnets are the most common commercial REPMs. REPMs have excellent hard magnetic properties, such as high magnetocrystalline anisotropy field H_{A}, high intrinsic coercivity H_{ci}, high or moderate high saturation magnetization 4πMₛ, high remanence Bᵣ, high Curie temperatures T_{C}, and high maximum energy product (BH)ₘₐₓ Nd—Fe—B magnets exhibit the highest room temperature magnetic properties while Sm—Co magnets are the ultimate choice for the applications at elevated temperatures in the range of 200-550° C. due to their excellent hard magnetic properties and thermal stability. REPMs have been widely used in energy conversion and storage, telecommunication, consumer electronics, magnetic storage, medical devices, sensors, and more.

However, REPMs have a high-risk of mechanical failure when subjected to mechanical stress such as vibration and mechanical shock since the intermetallic compounds of Nd₂Fe₁₄B, SmCo₅ and Sm₂Co₁₇ are very brittle intrinsically with an intergranular (Nd—Fe—B) or intragranular (Sm—Co) type fracture mechanism. Nd₂Fe₁₄B, SmCo₅ and Sm₂Co₁₇ compounds have the low symmetry tetragonal, hexagonal and rhombhedral crystal structures, respectively, that have an insufficient number of independent slip systems. Therefore, these compounds have little or no plastic deformation taking place before their fracture even though they have relatively high strength.

The commercial Sm—Co and Nd—Fe—B sintered magnets are brittle and prone to chipping, cracking or fracture in the courses of magnet manufacture, machining, shipping, assembly, and operation. The brittleness and poor machinability of these magnets leads to the production losses up to 30% and also imposes limitations on the magnet shapes and sizes. Especially, it is impossible for applications of REPMs subjected to high stress and vibration.

The improvement in the toughness of REPMs while maintaining their high magnetic performance would not only improve their manufacturing efficiency and machinability, reduce part failure rate and effectively use of expensive critical materials, but it would also greatly expand the market share for this class of permanent magnets, by offering opportunities for new applications, new shapes, and lower costs. Tougher REPMs could also make it possible for production of bulky magnets with even higher magnetic performance and larger dimensions. The tough magnets will be more robust for energy applications, more effective for the use of critical materials while reducing the pressure on critical material supply chain.

Improving the mechanical properties (mainly fracture toughness and flexural strength) of REPMs is of a great scientific, technical and practical significance. The research on the mechanical properties, strengthening and toughening of these magnets has been limitedly reported. Previous reports showed a 100% improvement in fracture toughness, 69% improvement in impact toughness, and 16% improvement in flexural strength for sintered Nd—Fe—B magnets through adjusting alloy compositions by the addition of small amounts of Nd, Dy and Pr; Al, Co, Cu, Ga, Mn, Nb, Ti, V, Zr or other transition metals, and mixtures thereof, and thus, forming fine precipitates within the grains, reducing grain size, engineering grain boundaries and/or lattice distortion. However, the alloying processes can change the electronic, magnetic and strain energy states of the lattice, or form alternative phases with completely different properties, especially the addition of non-magnetic elements, and thus, the hard magnetic properties are usually degraded.

The traditional and widely used alloying method makes magnet development higher cost, processing technique more complicate, and more resource-dependent that is associated with progressive resource exhaustion, supply uncertainty or even unavailability of critical elements/materials. Moreover, alloyed materials with complicated compositions may become more difficult to recycle. Up to now, the great challenge on effectively resolving the brittleness problem of the REPMs still remains.

Pending U.S. patent application Ser. No. 16/350,215 filed on Oct. 15, 2018, involves engineering the feedstock particle sizes and/or magnet grain sizes and subsequent grain boundary structure with a fixed chemical composition to substantially tune the mechanical toughness properties of the REPMs while maintaining their high magnetic performance. The formation of such heterogeneous microstructures, such as bi-modal, tri-modal, or multi-modal grain size structures, laminated, gridded, or gradient coarse/fine grain structures, or other microstructural heterogeneity and configurations, without changing the chemical compositions of magnets, was effective to increase toughness, as evidenced by an increased mechanical toughness property such as flexural strength and/or fracture toughness, of the REPMs. For the REPMs, heterogeneous structures and configurations with the combination of particle sizes or grain sizes ranging from nanometer, submicron (i.e. less than 1 micron) to several or tens of micron can have higher strength, while comparable ductility or brittleness compared with the microparticle structure in the commercial REPMs that have a single-modal coarse size of several or tens of micron made from commercial jet-milled powder precursors. The finer grains acting as the strengthening sites in the bi-modal, tri-modal, laminated, gridded or gradient coarse/fine grain size structures and the subsequent grain boundary engineering can slow down the propagation of micro-cracks, which in turn increasing the flexural strength and fracture toughness of the REPMs. On the other hand, the coarser grains of the microstructure have more anti-oxidation ability and the formation of stronger texture in the sintered magnets, which can result in little or no change to the hard magnetic properties.

### SUMMARY OF THE INVENTION

The present invention provides fine grain microstructures for REPMs such as including, but not limited to, Sm—Co and Nd—Fe—B permanent magnets as well as other permanent magnets, and their production in a manner to significantly enhance flexural strength and fracture toughness of the magnets with no or little sacrifice in the hard magnetic properties. The novel tough REPMs can have either homogeneous or heterogeneous refined grain microstructural architectures. In a certain embodiment of the invention, the fine grain microstructures are achieved by introducing a small amount of additive particle material into the magnet matrix, such as, particles comprising carbides, fluorides, nitrides, oxides, sulfides, etc., and/or their mixtures. The additive particle material comprises fine-sized, insoluble, chemically stable, and non-reactive with the magnet matrix. These additive materials can act effectively as both heterogeneous nuclei sites and grain growth inhibitors during subsequent heat treatment processes to produce refined grain structures of the REPMs. In a certain other embodiment of the invention, the fine grain structures are achieved by using magnet alloy feedstock powders with finer particle sizes. The resulting fine grains of the magnet acting as the strengthening sites can inhibit the crack nucleation and can also slow down the propagation of micro-cracks, which in turn increasing magnet's fracture toughness. The tough magnets made by these certain embodiments will be more robust for energy applications, more effective for the use of critical materials while reducing the pressure on critical material supply chain. Also, these embodiments are cost-effective, and also compatible with the existing manufacturing processes.

Pursuant to a certain illustrative embodiment of the invention, a first type of feedstock employed to make the tough REPM is a mixture of the fine magnet alloy powders (for example, 99.5-90 wt. %) and a small amount of (for example, 0.5-10 wt. %) fine-sized, insoluble and non-reactive additive particle material, such as, particles comprising carbides, fluorides, nitrides, oxides, sulfides, etc., and/or their mixtures. Pursuant to a certain other illustrative embodiment, a second type of feedstock comprises 100% finer magnet alloy feedstock powders made by cryomilling of commercial jet milled powder (or using other techniques described below) to have an average particle or grain sizes ranging from submicron scale to micron scale that is smaller than that of the commercial powders (usually average particle or grain sizes in micron scale). Either of the two different types of feedstocks is used to produce the sintered REPMs of the Sm—Co type, with refined grain structures whose average grain sizes are significantly smaller (e.g. less than 40 microns, such as about 20 to about 35 microns average grain size) than those of the commercial Sm—Co magnet counterparts that have a coarser single-modal micron grain size (e.g. about 40-45 microns for typical Sm₂Co₁₇ type sintered magnets. For Nd—Fe—B type sintered magnets, powder feedstocks pursuant to certain other embodiments of the invention can be used to produce refined grain structures whose average grain sizes are significantly smaller (e.g. less than 10 microns, such as about 1 to about 5 microns average grain size) than those of the commercial Nd—Fe—B sintered magnet counterparts that have a coarser single-modal micron grain size (e.g. about 10 microns). This, in turn, can effectively increase flexural strength (a mechanical toughness property) of these and other REPMs.

The additive particle material within the magnet matrix can act effectively as both heterogeneous nuclei sites and grain growth inhibitors during the heat treatment processes, which in turn resulting in refined grain structures of the REPMs. The additive particle material is fine-sized, insoluble, chemically stable, and non-reactive with the magnet matrix. Homogeneous dispersion of fine additive particle material is desirable to effective intragranular nucleation. On the other hand, the fine additive particle material on magnet grain boundaries would be preferable to the inhibition of grain growth due to the Zener pinning of grain boundaries. According to the Zener type model, the pinning force Fp from the fine additive particle materials to inhibit the grain growth is given by Fₚ=3fγ_{GB}/2r, where f is the additive particle volume fraction, γ_{GB} is the grain boundary energy per unit area, and r is the additive particle radius. Therefore, a higher volume fraction, a finer average size, and better-dispersed additive fine particles, which has larger pinning force, can lead to finer grain size in the sintered REPMs.

The additive particle material includes but not limited to, particles comprising carbides, fluorides, nitrides, oxides, sulfides, and/or combinations of any of these materials. The morphologies of the additive particle material includes, but not limited to, particles, fibers, rods, tubes, dendrites, whiskers, or mesoporous structures in either nano-, submicron-, and/or micron-scales, and/or combinations of any of these material morphologies.

In the certain other embodiment of the invention, when using the 100% finer magnet alloy feedstock powders preferably having an average particle size of 0.1 to less than 1.5 microns, more preferably 0.1 to 1.0 micron, as the second type of feedstock, the higher volume fraction ratio, finer particle size, and better-dispersion of the rare-earth oxide micro-particles, which are formed during the magnet production processes, plays the most important role to produce the refined grain microstructures in the sintered REPMs (for example, Sm—Co and Nd—Fe—B magnets), compared with those of the commercial type reference magnet made from 100% commercial jet milled powder.

Embodiments of the present invention thus relate to powder feedstock and refined grain microstructure for REPMs and their production methods. More particularly, the invention relates to feedstock and sufficiently fine grain microstructure for REPMs to impart significantly enhanced toughness, while maintaining or with a minimum sacrifice in the hard magnetic properties. The novel tough REPMs have either homogenous or heterogeneous refined grain structures, without changing the chemical compositions of magnets except the non-reactive additive materials. As mentioned before, to increase flexural strength of the REPMs via reducing the magnet grain size, two different types of feedstock can be used independently.

For purposes of further illustration and not limitation, an illustrative first type of feedstock comprises 99.9-90 wt. %, such as for example 99.5-95 wt. %, commercial jet-milled Sm—Co or Nd—Fe—B microparticle powders (average particle size of about 2.3-5 microns), and 0.1-10 wt. %, such as, 0.5-5 wt. % additive materials (for example, Sm₂O₃ or Nd₂O₃ microparticles with an average size of about 0.3-1 micron). An illustrative second type of feedstock comprises 100 wt. % modified finer Sm—Co or Nd—Fe—B particle powders (average particle size of about 1-1.5 micron) made from further cryomilling of the commercial jet-milled Sm—Co or Nd—Fe—B microparticle powders (average particle size of about 2.3-5 microns). Embodiments of the present invention are cost-effective and also compatible with the existing manufacturing processes. Therefore, this invention is advantageous in that it can be easily integrated with the current industry production line for sintered REPMs.

Practice of the present invention thereby provides rare earth permanent magnets comprising a microstructure having a refined grain structure that improves a mechanical toughness property of the magnets while maintaining the excellent magnetic properties of the magnets. The novel mechanically strengthened magnets developed in this invention will be more robust for energy applications, more effective for the use of critical materials while reducing the pressure on critical material supply chain.

For purposes of further illustration of the first illustrative embodiment, using the feedstock of well-mixed mixtures of 1 wt. % or 3 wt. % Sm₂O₃ submicron particles (with an average particle size of about 0.35 micron), and balance jet milled powders (with an average particle size of about 2.3 microns), the average flexural strength values of Sm₂O₃-added Sm₂CO₁₇ type Sm₂(CoFeCuZr)₁₇ sintered magnets were enhanced by 30% or greater, for example, by about 30% (about 148 MPa) and 62% (about 185 MPa), respectively. The highest flexural strength value of about 199 MPa was achieved for selected specimens with the addition of 3 wt. % Sm₂O₃ submicron particles that was enhanced by about 75%. These are relative to a flexural strength value of about 114 MPa for the commercial counterpart magnet made using 100% jet milled powders (with an average particle size of about 2.3 microns). Excellent magnetic properties were maintained with the maximum energy product (BH)ₘₐₓ values of about 26 MGOe, 26 MGOe, and 24.5 MGOe for the Sm₂O₃-added Sm₂(CoFeCuZr)₁₇ sintered magnets made from the feedstock of (100−x) wt. % jet milled powders +x wt. % (x=0, 1, 3) Sm₂O₃ cryomilled submicron particle powders, respectively. (BH)ₘₐₓ (about 24.5 MGOe) decreased by only about 5.8% (less than 6%) for the magnet with the addition of 3 wt. % Sm₂O₃ submicron powders while no decrease of (BH)ₘₐₓ for the magnet with the addition of 1 wt. % Sm₂O₃ submicron powders. There was almost no decrease of remanence Bᵣ values, those were about 10.6 kGs, 10.6 KGs, and 10.5 kGs for the Sm₂(CoFeCuZr)₁₇ sintered magnets with the addition of 0, 1, 3 wt. % Sm₂O₃ submicron particles, respectively. The intrinsic coercivity H_{ci} values were about 32.7 kOe, 32.9 KOe, 33.4 kOe for the Sm₂(CoFeCuZr)₁₇ sintered magnets with the addition of 0, 1, 3 wt. % Sm₂O₃ submicron particles, respectively. The H_{ci} values were slightly increased for the Sm₂O₃-added magnets due to the grain refinement with the addition of Sm₂O₃ submicron particles. That is, practice of the present invention achieved significant enhancement of mechanical toughness properties, such as flexural strength, with no or little degradation of the hard magnetic properties; e.g. (BH)ₘₐₓ, Bᵣ and H_{ci}, such as less than 6% degradation of (BH)ₘₐₓ, no decrease of Bᵣ and a slight increase of H_{ci} at room temperature (20° C.). The Sm₂O₃ submicron particles were well dispersed within the magnet matrix. The average grain sizes of the Sm₂O₃-added sintered magnets were about 32 microns and 22 microns for the magnets with the addition of 1 wt. % and 3 wt. % Sm₂O₃ submicron particles (with an average particle size of 0.35 micron), respectively. Whereas, the average grain size of the commercial counterpart magnet was about 45 microns. All the magnets mentioned in this embodiment have a single-modal grain size distribution.

For purposes of further illustration of the second illustrative embodiment of the invention, using a feedstock of well-mixed mixtures of a portion 1): 3 wt. % Sm₂O₃ submicron particles (with an average particle size of about 0.35 micron), and balance jet milled powders (with an average particle size of about 2.3 microns), and a portion 2: . 100% jet milled powders, the portion 1 was placed in the middle region of the magnet as 30 wt. % of the whole magnet while portion 2 was placed at both side regions as 35 wt. % of the whole magnet to form a laminated microstructure magnet. The average flexural strength value of the laminated Sm₂CO₁₇ type Sm₂(CoFeCuZr)₁₇ sintered magnets were enhanced by 62% (about 185 MPa) relative to a flexural strength value of about 114 MPa for the commercial magnet. Excellent magnetic properties were maintained in the laminated magnet. The values of (BH)ₘₐₓ Bᵣ and H_{ci} of the laminate magnet and commercial type reference magnet were, 26 MGOe; 26MGOe; 10.6 kGs, 10.6 kGs; 34.0 kOe, 32.7 kOe, respectively. There was no decrease of (BH)ₘₐₓ and Bᵣ values while an even slightly increased H_{ci} by 4% for the laminated magnet made with the modified microstructures pursuant to the invention compared with those of the commercial counterpart magnet. Novel laminated coarse/fine/coarse grain microstructural architecture was formed in this magnet. The Sm₂O₃ submicron particles were well dispersed within the middle region of magnet matrix, which has a finer average grain size of about 22 micron while the fine grain area was about 30 wt. % of the magnet. The two coarse grain side regions had an average grain size of about 34 micron and each of the coarse grain areas was about 35 wt. % of the magnet. Whereas, the average grain size of the commercial counterpart magnet was about 45 microns.

It should be mentioned that, there are always about 0.5 wt. % Sm₂O₃ microparticles with an average particle size of about 2.5-3.5 microns in the commercial sintered Sm—Co magnets while the agglomerates of a few of these Sm₂O₃ microparticles are also commonly observed. These Sm₂O₃ microparticles are “naturally” formed through a partial oxidization during the multi-step magnet fabrication processes, especially during the powder fabrication and handling processes, sintering and heat treatment processes. Whereas, the Sm₂O₃ microparticles are smaller (with an overall average particle size of about 0.5-2.3 microns) while better dispersed in the artificially Sm₂O₃-added Sm—Co sintered magnets. The artificially added Sm₂O₃ submicron particles are insoluble, chemically stable, and non-reactive with the Sm—Co magnet matrix. These Sm₂O₃ submicron particles, whose average particle size is about 0.35 μm, maintain their original fine particles in the sintered Sm—Co magnets.

The results shown in both the first and second embodiments of the invention indicate that the purposeful addition of a small amount of well-dispersed Sm₂O₃ fine submicron particles into the magnet matrix reduced effectively the grain sizes of the Sm₂CO₁₇ type sintered magnets. Accordingly, adding a small amount of Sm₂O₃ fine particles can be an economical and effective method to mechanically strengthen the magnets due to the formation of a refined grain microstructure while maintaining or little degrading magnetic properties for the Sm—Co sintered magnets.

For purposes of further illustration of the third illustrative embodiment of the invention, using a feedstock of 100 wt. % modified finer Sm₂CO₁₇ type particle powders (average particle size of about 1.3 micron (within a preferred range of 0.1 to less than 1.5 microns) made from further cryomilling of the commercial jet-milled Sm—Co microparticle powders (average particle size of about 2.3 microns), the average flexural strength values of Sm₂CO₁₇ type Sm₂(CoFeCuZr)₁₇ sintered magnets were enhanced by about 96% (about 223 MPa) while the highest flexural strength value of about 244 MPa for selected specimens that was enhanced by about 114%. These are relative to a flexural strength value of 114 MPa for the commercial counterpart magnet made using 100% commercial jet milled powders. Excellent magnetic properties were maintained with the maximum energy product (BH)ₘₐₓ (about 25 MGOe) decreased by only 3.8% (less than 4%) while with a degraded squareness on the 2^{nd} quadrant of demagnetization curve and an increased Bᵣ value (about 10.9 kGs), and almost no decrease of H_{ci} value (about 32.2 kOe) respectively. These are relative to the values of (BH)ₘₐₓ (about 26 MGOe), Bᵣ (about 10.6 kGs), and H_{ci} (about 32.7 kOe) for the commercial counterpart magnet. The average grain size of the Sm₂CO₁₇ type sintered magnets made from cryomilled finer feedstock powder was about 15 μm with a single-modal grain size distribution. There were about 0.65 wt. % well-dispersed Sm₂O₃ microparticles with an average particle size of about 1.5 μm in the refined grain magnet. Whereas, the average grain size of the commercial counterpart magnet was about 45 microns. There were about 0.5 wt. % Sm₂O₃ microparticles with an average particle size of about 3.4 μm in the commercial sintered Sm—Co magnets while the agglomerates of a few of these Sm₂O₃ microparticles were commonly observed.

In the three further illustrative embodiments just discussed, the Sm—Co bulk sintered magnets have either a homogenous or heterogeneous laminated coarse/fine grain microstructure. Other heterogeneous grain structures, such as tri-modal grain structure, multi-modal grain structure, gridded fine/coarse grain structure (i.e. square honeycomb fine/coarse grain structure), gradient grain structures, (such as having larger grains progressing to smaller grains from one side to another side across the microstructure, or having larger grains progressing to smaller grains those are in the central areas and then progressing to larger grains, from one side to another side across the microstructure, or verse versa), or other refined microstructural heterogeneity and configurations, can also be produced in the REPMs using the feedstock and production process thereof developed in this invention. On the other hand, besides the powder metallurgy processing, the grain-refined structures can also be introduced into the REPMs by other fabrication methods including, but not limited to, hot pressing, die-upset, friction consolidation extrusion, hot extrusion, 3D printing, surface mechanical attrition treatment (SMAT), equal channel angular extrusion (ECAE), hot accumulative roll bonding (ARB), hot asymmetric rolling, high pressure torsion (HPT), hot drawing, mechanical milling, etc.

### BRIEF DESCRIPTION OF THE DRAWINGS

FIG. 1 shows morphology (SEM images) and corresponding particle size distribution of Sm₂O₃ submicron powders made by cryomilling in immersed LN₂ for 2 hrs (5000×, shown in the left image), according to one embodiment of the invention. The right column is the corresponding enlarged image (10,000×) from the selected area (marked by the red oval). The average particle size was about 0.35 μm. These and other particle size measurements and results described herein were obtained from the SEM images of the particles analyzed by the Image J software.

FIG. 2 shows morphology (SEM images) and corresponding particle size distributions of Sm₂CO₁₇ type Sm₂(CoFeCuZr)₁₇ jet milled powder (1500×, shown in top row) and further cryomilled powder in LN₂ for 2 hrs (shown in bottom row), according to one embodiment of the invention. The right column is the corresponding enlarged images (5000×) from the selected areas (marked by the red ovals). The average particle sizes were about 2.3 μm and 1.3 μm for the jet milled powder and cryomilled powder, respectively.

FIG. 3 presents typical flexural stress-strain curves for selected Sm₂O₃-added Sm₂(CoFeCuZr)₁₇ sintered magnets made from the feedstock of (100−x) wt. % jet milled powders +x wt. % (x=0, 1, 3) Sm₂O₃ cryomilled submicron powders, according to an embodiment of the process of the invention. The highest flexural strength value of about 199 MPa was achieved for selected specimen with the addition of x=3 wt. % Sm₂O₃ submicron particles that was enhanced by about 75%.

FIG. 4 presents demagnetization curves of selected Sm₂O₃-added Sm₂(CoFeCuZr)₁₇ sintered magnets made from the feedstock of (100−x) wt. % jet milled powders +x wt. % (x=0, 1, 3) Sm₂O₃ cryomilled submicron powders, according to an embodiment of the process of the invention.

FIG. 5 illustrates typical flexural stress-strain curves for laminated coarse/fine/coarse grain Sm₂(CoFeCuZr)₁₇ sintered magnets (ie. laminated magnet) made from the feedstock of a well-mixed mixture of 97 wt. % jet milled powders +3 wt. % Sm₂O₃ cryomilled submicron powders as 30 wt. % of the magnet that was put in the middle region of magnet while 35 wt. % of jet milled powder was put at each of both side regions of the magnet, according to an embodiment of the process of the invention. As a comparison, a typical flexural stress-strain curve of commercial type magnet (ie. reference magnet) with a single modal coarse grain distribution made from 100 wt. % jet milled powder was also shown in FIG. 5.

FIG. 6 illustrates typical demagnetization curve for laminated coarse/fine/coarse grain Sm₂(CoFeCuZr)₁₇ sintered magnets (ie. laminated magnet) made from the feedstock of a well-mixed mixture of 97 wt. % jet milled powders +3 wt. % Sm₂O₃ cryomilled submicron powders as 30 wt. % of the magnet that was put in the middle region of magnet, while 35 wt. % of jet milled powder was put at each of both side regions of the magnet, according to an embodiment of the process of the invention. As a comparison, a typical demagnetization curve of commercial type magnet (ie. reference magnet) made from 100 wt. % jet milled powder was also shown in FIG. 6.

FIG. 7 shows typical flexural stress-strain curve of refined grain Sm₂(CoFeCuZr)₁₇ magnet (ie. refined grain magnet) made from 100 wt. % finer particle powder cryomilled in LN₂ for 2 hrs, according to an embodiment of the process of the invention. The highest flexural strength value of 244 MPa was achieved in this specimen that was enhanced by about 114%. As a comparison, a typical flexural stress-strain curve of commercial type magnet (ie. reference magnet) made from 100 wt. % jet milled powder with a flexural strength value of 114 MPa was also shown in FIG. 7.

FIG. 8 shows demagnetization curves of refined grain Sm₂(CoFeCuZr)₁₇ magnet (i.e. refined grain magnet) made from 100 wt. % cryomilled powder in LN₂ for 2 hrs and the commercial type magnet made from 100 wt. % jet milled powder, according to an embodiment of the process of the invention. As a comparison, a typical demagnetization curve of commercial type magnet (ie. reference magnet) made from 100 wt. % jet milled powder was also shown in FIG. 8.

FIG. 9 shows morphology (optical photomicrographs, 100×, shown in the top left images) and corresponding grain size distribution (bottom images) of cross-section microstructures of selected Sm₂O₃-added Sm₂(CoFeCuZr)₁₇ sintered magnets made from the feedstock of (100−x) wt. % jet milled powders +x wt. % (x=0, 3) Sm₂O₃ cryomilled submicron particles. The right column is the corresponding enlarged images (400×) from the selected areas (marked by the red ovals). The average grain size was about 22 μm for the magnet with the addition of 3 wt. % Sm₂O₃ submicron particles. Whereas, the average grain size of the commercial counterpart magnet (x=0 wt. %) was about 45 μm. Both magnets have a single-modal grain size distribution. The specimens were mechanically polished then etched with 2% nital etchant for the metallographic examination. Grain size set forth herein and elsewhere in the specification were measured from optical images of the respective microstructures analyzed by Image J software.

FIG. 10 shows morphology of cross-section microstructures (optical photomicrographs, 100×, shown in the top image) and corresponding grain size distribution (bottom images) from selected fine and coarse grain areas (marked by the red ovals) of the laminated coarse/fine/coarse grain Sm₂(CoFeCuZr)₁₇ sintered magnet. The middle column is the corresponding enlarged images (1000×) from the selected coarse and fine areas (marked by the red ovals), respectively. The magnet was made from the feedstock of a well-mixed mixture of 97 wt. % jet milled powders +3 wt. % Sm₂O₃ cryomilled submicron powders as 30 wt. % of the magnet that was put in the middle region of magnet while 35 wt. % of jet milled powder was put at each of both side regions of the magnet. Novel laminated coarse/fine/coarse grain microstructural architecture was formed in this magnet. The finer average grain size in the magnet central part was about 22 μm. The two coarse grain side regions had an average grain size of about 34 μm. Whereas, the average grain size of the commercial counterpart magnet was about 45 μm as shown in FIG. 9.

FIG. 11 shows morphology (optical photomicrographs, 100×, shown in the left image) and corresponding grain size distribution of cross-section microstructures of refined grain Sm₂(CoFeCuZr)₁₇ magnet made from 100 wt. % cryomilled powder in LN₂ for 2 hrs. The right column is the corresponding enlarged image (400×) from the selected area (marked by the red oval). The average grain size of the refined grain magnets was about 15 μm with a single-modal grain size distribution. The specimen was mechanically polished then etched with 2% nital etchant for the metallographic examination.

FIG. 12 shows morphology (optical photomicrographs, 1000×) and particle size distribution of Sm₂O₃ microparticles (in gray color) for the Sm₂(CoFeCuZr)₁₇ refined grain magnet (shown in the bottom image) and commercial reference magnet (shown in the top image) those also shown in FIGS. 9 and 11, respectively. These particle size results were obtained from the optical photomicrographs of the particles analyzed by the Image J software.

### DETAILED DESCRIPTION OF THE INVENTION

Embodiments of the present invention relates to rare earth permanent magnets (REPMs) having a sufficiently refined grain microstructure to provide significantly enhanced toughness; i.e. resistance-to-fracture as evidenced by enhanced mechanical toughness property such as flexural strength and/or fracture toughness, while maintaining or with a minimum sacrifice in the hard magnetic properties, and the method of their manufacture. Embodiments of the present invention can be employed to make REPMs that include, but are not limited to, Sm—Co, Nd—Fe—B and other REPMs.

The REPMs made pursuant to certain embodiments of the invention have refined homogeneous or heterogeneous grain microstructures. To increase flexural strength and/or fracture toughness of the REPMs, the sufficiently refine grain structures were achieved in one embodiment by introducing a small amount of fine-sized, insoluble, chemically stable, and non-reactive additive particle material into the magnet matrix, such as, carbides, fluorides, nitrides, oxides, sulfides, and/or their mixtures, or, alternatively, by using feedstock powders with finer particle sizes than that of conventional ones.

For purposes of the present invention, the carbide-based additive particle material can include, but is not limited to: B₄C, BC₃, BaC₂, Be₂C, Al₄C₃, CaC₂, CeC₂, Cr₃C₂, Cr₄C, Cr₈C₂, Fe₃C, LaC₂, Li₂C₂, Mo₂C, MoC, Mn₃C, SiC, SrC₂, TaC, ThC, TiC, U₂C₃, WC, (W,Ti) C, W₂C, YC₂, ZrC, ZrC₂, or a combination of any of these materials. The fluoride-based additive particle material can include, but is not limited to: AcF₃, AIF₃, AuF₇, AuF₃, AuF₅, AuF, BaF₂, BeF₂, BiF₅, BiF₃, BF, BF₃, CdF₂, CaF₂, CeF₃, CrF₆, CrF₅, CrF₄, CrF₃, CrF₂, CoF₂, CoF₃, CuF, CuF₂, DyF₃, GaF₃, FeF₂, FeF₃, GeF₂, HfF₄, InF₃, IrF₆, KAIF₄, K₃CuF₆, K₂NiF₆, LaF₃, LiF, LiBeF, LiNaKF, MgF₂, MnF₂, MnF₃, MnF₄, Hg₂F₂, HgF₂, HgF₄, MoF₆, MoF₄, MoF₄, NdF₃, NiF₂, NbF₄, NbF₅, OsF₆, OsF₅, PF₅, PF₃, PbF₂, PbF₄, PdF₂, PdF₄, PdF₃, PtF₆, PtF₅, PtF₄, ReF₇, ReF₆, RhF₃, RuF₆, SbF₅, SbF₃, SmF₃, SnF₂, SnF₄, TaF₅, TeF₆, TeF₄, TiF₄, TiF₃, UF₅, UF₄, VF₅, VF₄, VF₃, WF₆, WF₅, WF₄, WOF₄, YbF₃, ZnF₂, ZrF₄, or a combination of any of these additive materials. The nitride-based additive particle material can include, but not limited to: AlN, Ag₃N, BN, Li₃N, (CN)₂, Cu₃N, Fe₂N, Fe₄N, Fe₁₆N₂, GaN, Hg₃N₂, InN, M₃N₂ (M=alkaline-earth metals: Ba, Be, Ca, Mg, Sr, Ra), Na₃N, NbN, P₃N₅, S₂N₂, SAN₄, ScN, Se₄N₄, Si₃N₄, TaN, Ta₂N, Ta₃N₅, TiN, TiAIN, TiCN, TIN, W₂N, WN, WN₂, YN, VN, Zn₃N₂, ZrN, or a combination of any of these additive materials. The oxide-based additive particle material can include, but is not limited to: AC₂O₃, Ag₂O, Al₂O₃, Al₁₈B₄O₃₃, Al₆BeO₁₀, Al₂MgO₄, Au₂O, Au₂O₃, BaO, BeO, Bi₂O₃, Bi₂O₅, B₂O₃, CaO, Ce₂O₃, CeO₂, CdO, CoO, CrO, Cr₂O₃, CrO₂, CrO₃, CO₂O₃, Cs₂O, Cu₂O₅Yb₂, CuFe₂O₄, Cu₂O, CuO, Dy₂O₃, Er₂O₃, Eu₂O₃, Fr₂O, Gd₂O₃, GaO, Ga₂O₃, GeO, GeO₂, HfO₂, In₂O, InO, In₂O₃, Ir₂O₃, Fe₃O₄, FeO, Fe₂O₃, Hg₂O, HgO, K₂O, K₂MnO₄, K₂Ti₆O₁₃, La₂O₃, Li₂O, Lu₂O₃, Mg₂B₂O₅, MgO, Mn₃O₄, MnO, Mn₂O₃, MnO₂, Mn₂O₅, Mn₂O₇, MoO₂, Mo₂O₅, Na₂O, Nd₂O₃, NiFe₂O₄, NiO, Ni₂O₃, Nb₂O₃, Os₂O₃, OsO₃, OsO₄, PbO, PbO₂, PdO, PdO₂, Pr₆O₁₁, Pt₃O₄, PtO, Pt₂O₃, PuO₂, Pu₂O₅, RaO, Rh₂O₃, Rb₂O, RuO₂, RuO₄, Sb₂O₅, SC₂O₃, Se₃O₄, SiO₂, Sm₂O₃, SnO, SnO₂, SrO, Ta₂O₃, Ta₂O₅, Tb₄O₇, TCO, TiO, Ti₂O₃, TiO₂, T₁₂O₃, Tm₂O₃, U₂O₅, VO, V₂O₃, VO₂, V₂O₅, VOCl₂, Yb₂O₃, WCl₂O₂, W₂O₃, WO₂, W₂O₅, YBa₂Cu₃O₇, Y₂O₃, ZnO, ZrO₂, or combinations of any of these additive materials. The sulfide-based additive particle material can include, but is not limited to: Al₂S₃, Ag₂S, As₂S₃, BaS, BeS, Bi₂S₃, B₂S₃, CdS, CaS, CeS, Ce₂S₃, Cr₂S₃, CoS, CoS₂, Cu₂S, CuS, Dy₂S₃, Er₂S₃, EuS, Gd₂S₃, Ga₂S₃, GeS, GeS₂, HfS₂, HO₂S₃, In₂S, InS, FeS, FeS₂, La₂S₃, LaS₂, La₂O₂S, Li₂S, MgS, MnS, HgS, MoS₂, Na₂S, Nd₂S₃, NiS, NdS, K₂S, PbS, Pr₂S₃, Sb₂S₃, Sm₂S₃, SC₂S₃, SiS₂, SnS, SnS₂, SrS, Tb₂S, ThS₂, Tm₂S₃, TiS₂, US₂, V₂S₃, WS, WS₂, Yb₂S₃, Y₂S₃, Y₂O₂S, ZnS, and ZrS₂, or a combination of any of these additive materials.

For purposes of illustration and not limitation, one exemplary feedstock comprises of 99.5-90 wt. % commercial jet-milled Sm—Co or Nd—Fe—B microparticle powders (average particle size of about 2.3-5 μm), and 0.5-10 wt. % fine-sized additive particle material comprising for example, Sm₂O₃ or Nd₂O₃ particles with an average particle size of about 0.3-1 μm wherein the particle size measurements described here and elsewhere in this application were obtained from the SEM images of the particles analyzed by the Image J software. As a result, practice of the invention can be easily integrated with the current industry production line for sintered REPMs.

In certain embodiments, the powders can be mixed together under nitrogen, argon or other non-reactive atmosphere in a mixer or mill for greater than 0 to 1 hours or more as needed. The powders can be formed into a green compact and consolidated by techniques that include, but are not limited to, powder metallurgy processing, hot pressing, friction consolidation extrusion, hot extrusion, 3D printing, surface mechanical attrition treatment (SMAT), equal channel angular extrusion (ECAE), hot accumulative roll bonding (ARB), hot asymmetric rolling, high pressure torsion (HPT), hot drawing, and mechanical milling. The REPMs with refined grain microstructures pursuant to embodiments of the invention can maintain the hard magnetic properties without substantial degradation of the hard magnetic properties such as (BH)ₘₐₓ, H_{ci}, and Bᵣ . The tough REPMs will be more robust for energy applications and can be less dependent on the critical element resources.

The following examples are offered for purposes of further illustration, but not limitation, with respect to the present invention:

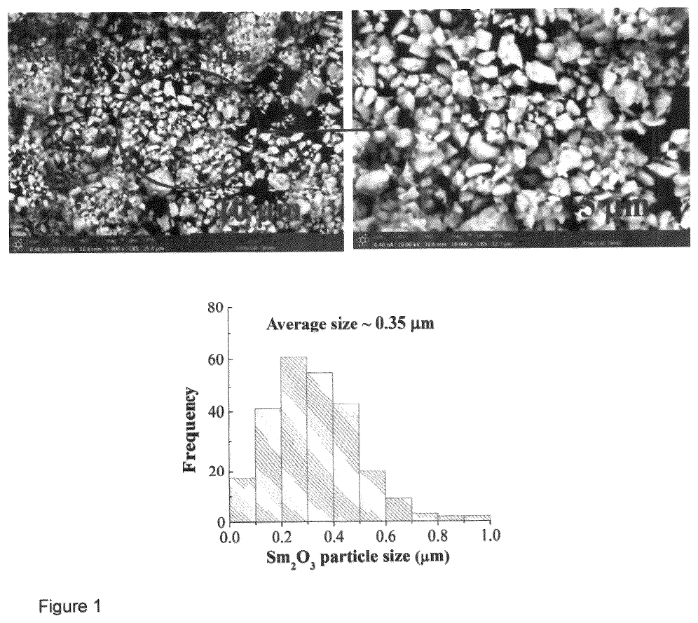

Dry samarium (III) oxide powder (Sm₂O₃, Alfa Aesar, REacton®, 99.99% (REO), Stock No. 11230-14) after cryomilled for 2 hrs in LN₂ with a SPEX 6875 Freezer/Mill were composed of fine irregular particles with a particle size mainly in the range of about 0.1-0.5 μm and an average particle size of about 0.35 μm and few-sharp edges, as shown in FIG. 1. The dry samarium oxide microparticle powders to be cryomilled were first sealed in a polycarbonate grinding vial under either gaseous Ar or N₂ atmosphere inside of a glove box, an Ar glove box being used for the examples. The entire cryomilling process was conducted with the grinding vial immersed in liquid nitrogen (LN₂) on the SPEX 6875D Freezer/Mill, which has a LN₂ tank that is connected to a dewar container as a continuous LN₂ source. The cryomilling cycle sequence was cryomilling for 10 minutes and then pausing for 2 minutes to cool down the powders. Ten (10) such cryomilling cycle sequences were applied in this and the other examples herein, the total multiple-cycle cryomilling time being 2 hours excluding the pause times.

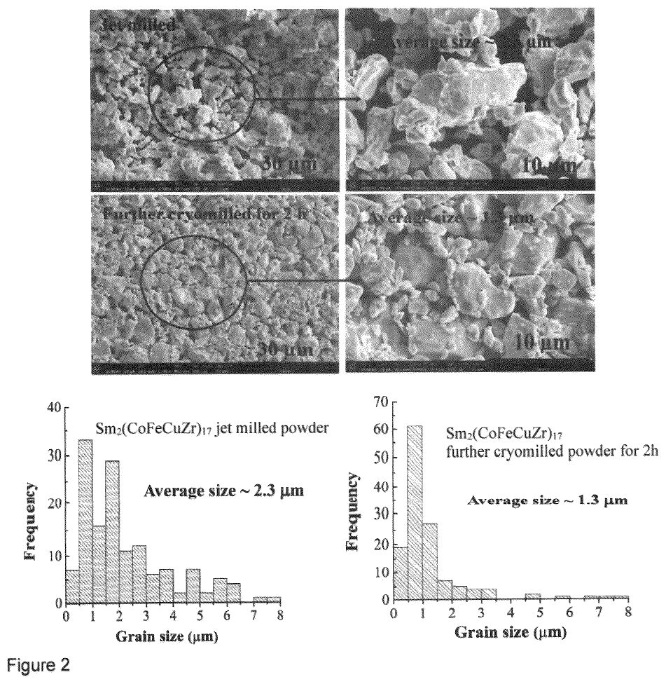

The overall particle size range of the Sm₂O₃ cryomilled powders was within about 0.05-1 μm. The Sm₂CO₁₇ type Sm₂(CoFeCuZr)₁₇ conventional jet milled powders were composed of irregular microparticles with a particle size mainly in the range of about 0.7-3.0 μm and an average particle size of about 2.3 μm, as shown in FIG. 2. The overall particle size range of the jet milled powders was within about 0.7-8 μm. However, the Sm₂(CoFeCuZr)₁₇ powders further cryomilled for 2 hrs were composed of finer irregular microparticles with a particle size mainly in the range of about 0.5-1.5 μm and an average particle size of about 1.3 μm and few sharp edges. The overall particle size range of the cryomilled powders was within about 0.5-8 μm (see FIG. 2). These particle size results were obtained from the SEM images analyzed by image J software. Both the jet milled microparticles and the further cryomilled finer Sm—Co particles had a single-crystal structure.

Besides cryomilling in liquid nitrogen, the other finer powder preparation methods wherein the particle size ranging from nanometer, submicron, and micron scale or their mixtures, that is smaller than that of commercial jet-milled powders (that have a typical average particle size of about 2.3-5 micron), include but are not limited to, some top-down and bottom-up approaches, such as, multiple-cycle jet milling in nitrogen (N₂) gas atmosphere, low or high energy ball milling at room temperature in inert gas (Ar, N₂, or He) or in solvent media (acetone, ethanol, hexane, heptane, toluene, etc.), surfactant-assisted high energy ball milling at room temperature or immersed in the liquid nitrogen, inert gas atomization, gas condensation, spark erosion, chemical precipitation, sol-gel, pyrolysis and hydrothermal synthesis, thermal decomposition, plasma arcing, chemical reduction or oxidization, gas-solid reaction, vapor-liquid-solid (VLS) process, carburizing, carbonitriding, nitriding, chemical vapor deposition (CVD), physical vapor deposition (PVD), hydrogen decrepitation (HD), hydrogen decrepitation deabsorbation recombination (HDDR) process, severe plastic deformation (SPD), electrodeposition, colloidal lithography, atomic layer deposition (ALD), etc.

The cryomilled Sm₂O₃ sub-micron powders produced in this invention were then mixed with the jet milled precursor powders under a nitrogen atmosphere in a SPEX 8000M Mixer/Mill without any milling balls for a time of 7 minutes, which more generally can be up to 15 minutes or more or other suitable blending time. The particle mixtures then are subjected to conventional powder metallurgy method (i.e. pressing to form a compact, sintering the pressed compact followed by solution heat treating, tempering, and aging) to produce a bulk magnet with grain size and grain boundary engineering or modified microstructural architectures.

The particular illustrative powder metallurgy steps typically include cold compaction of the magnetically aligned powder mixture to form a green compact and then sintering the green compact, although the powders can be formed into a green compact and consolidated by techniques that include, but are not limited to, powder metallurgy processing, hot pressing, friction consolidation extrusion, hot extrusion, 3D printing, surface mechanical attrition treatment (SMAT), equal channel angular extrusion (ECAE), hot accumulative roll bonding (ARB), hot asymmetric rolling, high pressure torsion (HPT), hot drawing, and mechanical milling. The powder metallurgy method optionally can include preparation of ingot chips by strip casting or bulk ingot by induction melting or arc melting, hydrogen decrepitation (HD) or crushing into coarse powders of about 200-500 μm or less sizes, jet milling or ball milling into fine microparticles of the average particle sizes described above, magnetically aligning by a 4 or 7 Tesla pulsed magnetic field and pre-pressing powder mixtures into green compacts by a pressure of 35,000 psi (about 241 MPa) or higher using a Nikisso CL15-45-30 iso-static press, and subsequent heat treatment procedure, including sintering, solution, temper, and aging.

In the examples and results described above and below, the green compacts were pre-pressed by a pressure of 241 MPa using the above Nikisso CL15-45-30 iso-static press and sintered. The 2:17 type Sm₂(CoFeCuZr)₁₇ were sintered at 1190-1250° C. for 1-2 hrs, solution tempered at 1150-1185° C. for 1-7 hrs, and aged at 800-850° C. for 5-10 hrs then cooling to 400° C. at a ramp rate of 0.7-1.0° C./min., further aging at 400° C. for 1-10 hrs.

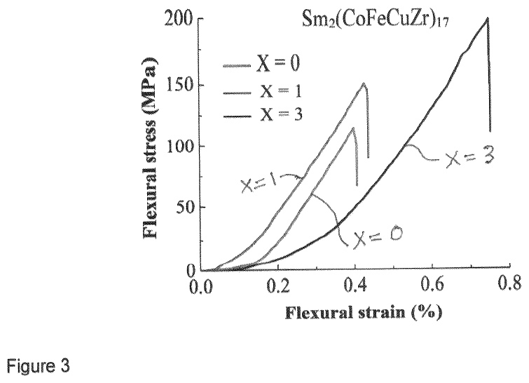

FIG. 3 shows the typical flexural stress-strain curves for selected Sm₂O₃-added Sm₂(CoFeCuZr)₁₇ sintered magnets made from the feedstock of (100−x) wt. % jet milled powders +x wt. % (x=0, 1, 3) Sm₂O₃ cryomilled submicron powders. By engineering the grain size and grain-boundary microstructure, the average flexural strength values of the sintered Sm₂CO₁₇ type magnets were enhanced by about 30% and 62% (about 148 MPa and 185 MPa for the samples with x=1 and 3 wt. %, respectively) compared to that of 114 MPa for the reference sample with x=0. Whereas, the highest flexural strength value of about 199 MPa was achieved for selected specimens with the addition of x =3 wt. % Sm₂O₃ submicron particles that was enhanced by about 75%. Flexural strength values reported above were measured using the 3-point bending ASTM flexure test no. C1161-13. Fracture toughness, another mechanical toughness property, can be measured by the Charpy V-notch or IZOD ASTM tests no. C1421-16.

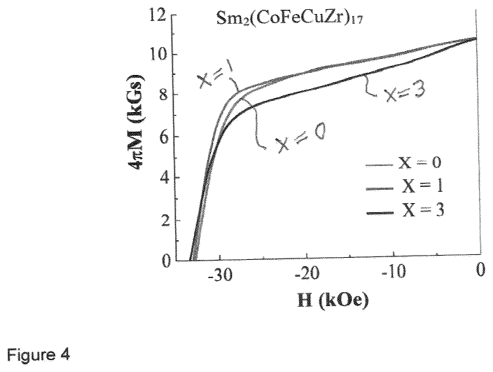

Demagnetization curves are shown in FIG. 4 for the Sm₂(CoFeCuZr)₁₇ sintered magnets made from the feedstock of (100−x) wt. % 2:17 type jet milled (JM) powders +x wt. % (x=0, 1, 3) Sm₂O₃ cryomilled submicron particle powders. Excellent hard magnetic properties were maintained with the maximum energy product (BH)ₘₐₓ values of about 26 MGOe, 26 MGOe, and 24.5 MGOe for the Sm₂(CoFeCuZr)₁₇ sintered magnets added with x=0, 1, and 3 wt. % Sm₂O₃ submicron particles, respectively. (BH)ₘₐₓ decreased (about 24.5 MGOe) by only about 5.8% (less than 6%) for the magnet with the addition of x=3 wt. % Sm₂O₃ while no decrease of (BH)ₘₐₓ for the magnet with the addition of 1 wt. % Sm₂O₃. There was almost no decrease of remanence Bᵣ values, those were about 10.6 kGs, 10.6 kGs, and 10.5 kGs for the Sm₂(CoFeCuZr)₁₇ sintered magnets with the addition of 0, 1, 3 wt. % Sm₂O₃ submicron particles, respectively. The intrinsic coercivity H_{ci} values were about 32.7 kOe, 32.9 kOe, 33.4 kOe for the Sm₂(CoFeCuZr)₁₇ sintered magnets with the addition of 0, 1, 3 wt. % Sm₂O₃ submicron particles, respectively. The H_{ci} values were slightly increased for the Sm₂O₃-added magnets due to the grain refinement with the addition of Sm₂O₃ submicron particles. The density p of these Sm₂(CoFeCuZr)₁₇ sintered magnets with the addition of 0, 1, 3 wt. % Sm₂O₃ was about 8.4 g/cc, which was about 99% of the theoretical value.

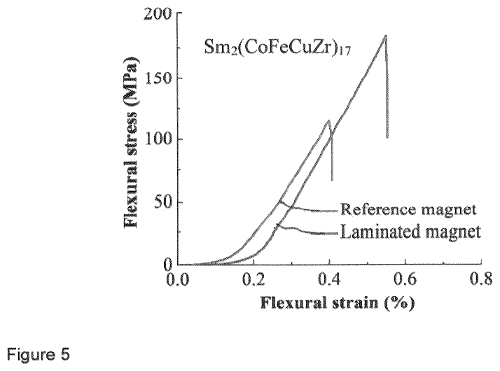

FIG. 5 shows typical flexural stress-strain curves for laminated coarse/fine/coarse grain Sm₂(CoFeCuZr)₁₇ sintered magnets made from the feedstock of a well-mixed mixture of 97 wt. % jet milled powders +3 wt. % Sm₂O₃ cryomilled submicron particle powders as 30 wt. % of the magnet that was put in the middle region of magnet. Whereas, 35 wt. % of 100% jet milled powder was put at each of both side regions of the magnet. By engineering the grain size, grain-boundary and microstructural architecture, the average flexural strength values of the laminated Sm₂(CoFeCuZr)₁₇ sintered magnets were enhanced by 62% (about 185 MPa) relative to a flexural strength value of 114 MPa for the commercial reference magnet.

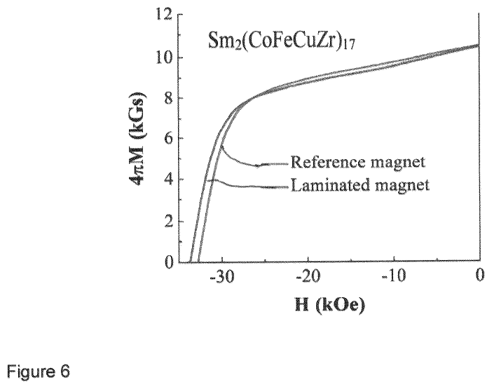

FIG. 6 shows demagnetization curves of the laminated Sm₂(CoFeCuZr)₁₇ sintered magnets. Excellent magnetic properties were maintained in the laminated magnet. The values of (BH)ₘₐₓ Bᵣ and H_{ci} of the laminate magnet and commercial type reference magnet were, 26 MGOe; 26MGOe; 10.6 kGs, 10.6 kGs; 34.0 kOe, 32.7 kOe, respectively. There was no decrease of (BH)ₘₐₓ and Bᵣ values while an even slightly increased H_{ci} by 4% for the laminated magnet made with the modified microstructures pursuant to the invention compared with those of the commercial counterpart magnet. These Sm₂(CoFeCuZr)₁₇ sintered magnets have a density p of about 8.4 g/cc, which was about 99% of the theoretical value.

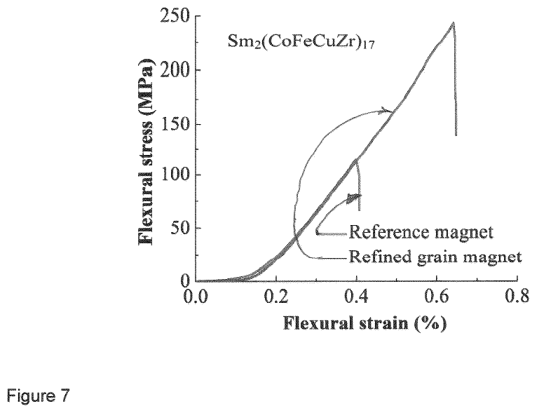

FIG. 7 shows typical flexural stress-strain curves of refined grain Sm₂(CoFeCuZr)₁₇ magnet made from 100 wt. % finer particle powder cryomilled in LN₂ for 2 hrs and the commercial type magnet made from 100 wt. % jet milled powder. By engineering the grain size and grain-boundary microstructure, the average flexural strength value of Sm₂(CoFeCuZr)₁₇ sintered magnets made from 100 wt. % cryomilled powder was enhanced by about 96% (about 223 MPa) while the highest flexural strength value of about 244 MPa was achieved for the selected specimen, which was enhanced by about 114%, compared to 114 MPa for the commercial counterpart sample made from 100 wt. % jet milled powder.

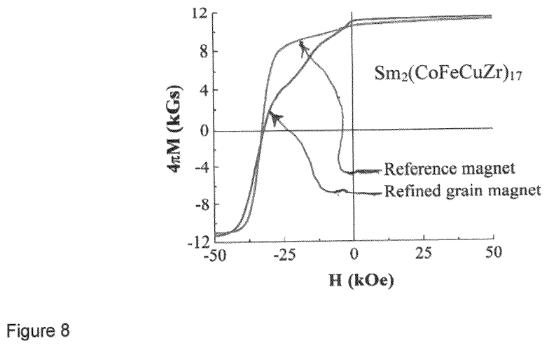

FIG. 8 shows demagnetization curves of the refined grain Sm₂(CoFeCuZr)₁₇ magnet made from 100 wt. % finer powder cryomilled for 2 hrs. Excellent magnetic properties were maintained with the maximum energy product (BH)ₘₐₓ (about 25 MGOe) decreased by only 3.8% (less than 4%) while with a degrade squareness on the 2^{nd} quadrant of demagnetization curve while an increased Bᵣ value (about 10.9 kGs), and almost no decrease of H_{ci} value (about 32.2 kOe) respectively. These are relative to values of (BH)ₘₐₓ (about 26 MGOe), Bᵣ (about 10.6 kGs), and H_{ci} (about 32.7 kOe) for the commercial reference magnet. Sm₂(CoFeCuZr)₁₇ sintered magnet density p was about 8.4 g/cc, which was about 99% of the theoretical value.

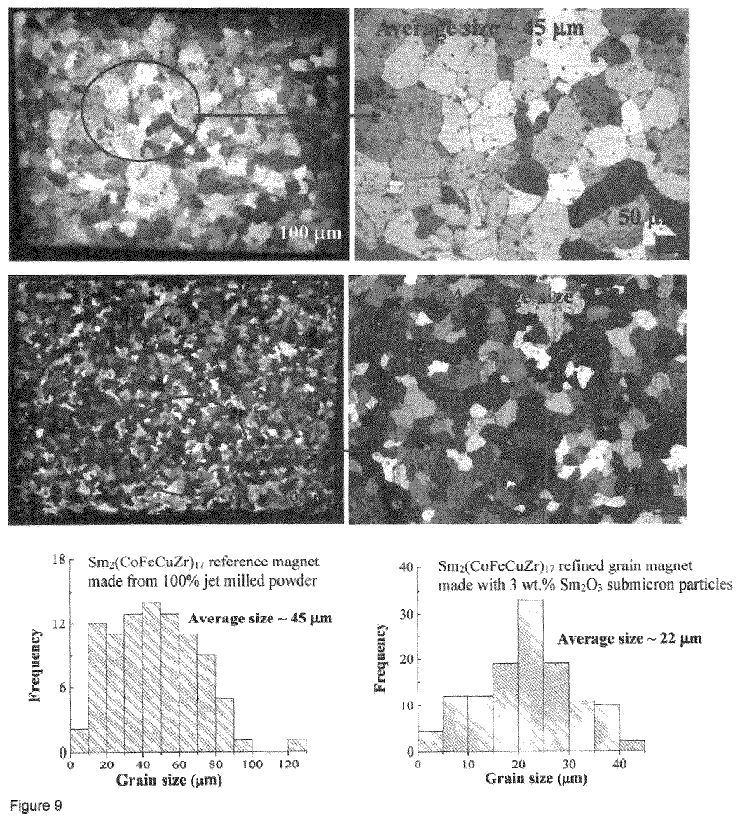

With respect to sintered microstructures, a typical single-modal coarse grain size structure with an average grain size of about 45 μm was observed in the 2:17 type Sm₂(CoFeCuZr)₁₇ commercial-type sintered magnet made from 100 wt. % 2:17 type jet milled powders, as shown in FIG. 9. In contrast, the Sm—Co sintered magnets made from the mixture feedstocks of Sm₂O₃-submicron particles and jet milled magnet alloy powders pursuant to the invention have a refined single-modal grain size microstructure, as shown in FIG. 9. The average grain sizes of the Sm₂O₃-added sintered magnets were about 32 μm and 22 μm for the magnets with the addition of 1 wt. % and 3 wt. % Sm₂O₃ submicron particles, respectively. These grain size results were obtained from the optical images of the microstructures analyzed by Image J software. This refined grain sized microstructure resulted in considerably higher flexural strength and higher fracture toughness, and comparable magnetic properties, compared with the commercial reference magnet with a single-modal coarse grain sized microstructure as shown in FIG. 9. The fine grains acting as the strengthening sites can inhibit the crack nucleation and also slow down the propagation of micro-cracks, which in turn increasing magnet's flexural strength and fracture toughness.

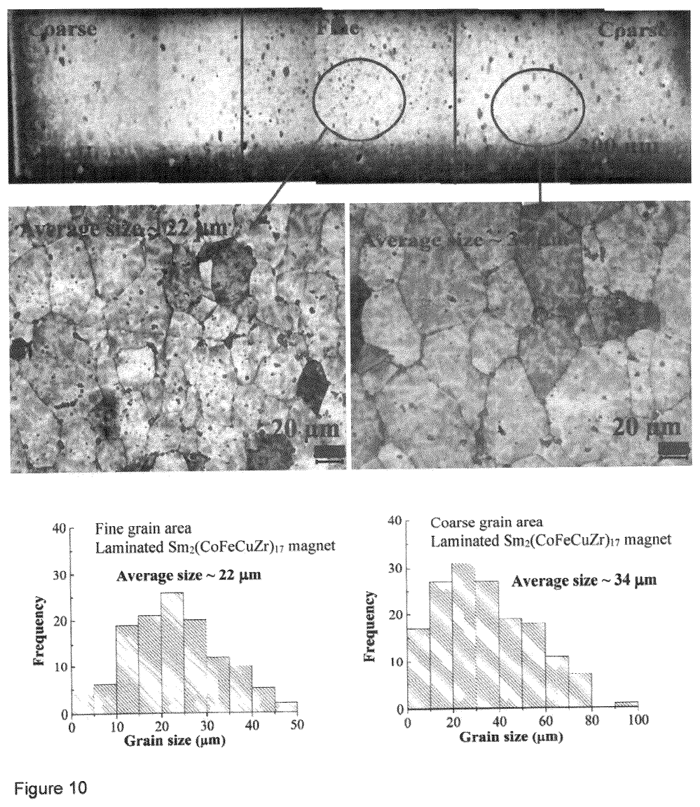

FIG. 10 shows morphology of cross-section microstructures and corresponding grain size distribution from selected fine and coarse regions of the laminated coarse/fine/coarse grain Sm₂(CoFeCuZr)₁₇ sintered magnet. The magnet was made from the feedstock of a well-mixed mixture of 97 wt. % jet milled powders +3 wt. % Sm₂O₃ cryomilled submicron powders as 30 wt. % of the magnet that was put in the middle region of magnet. The 35 wt. % of jet milled powder was put at each of both side regions of the magnet. Novel laminated coarse/fine/coarse grain microstructural architecture was formed in this magnet. The finer average grain size in the magnet central (middle) region was about 22 μm. The two coarse grain areas at each side region of the magnet had an average grain size of about 34 μm. Whereas, the average grain size of the commercial counterpart magnet was about 45 μm as shown in FIG. 9. The enhancement of flexural strength of the laminated Sm—Co sintered magnets resulted from the grain size refinement with the contributions from both localized finer grain central regions (about 30 wt. % of the magnet) and a general grain size reduction from the coarse grain matrix. The localized finer grain region is more effective in preventing or propagation via acting as strengthening sites than the coarser matrix.

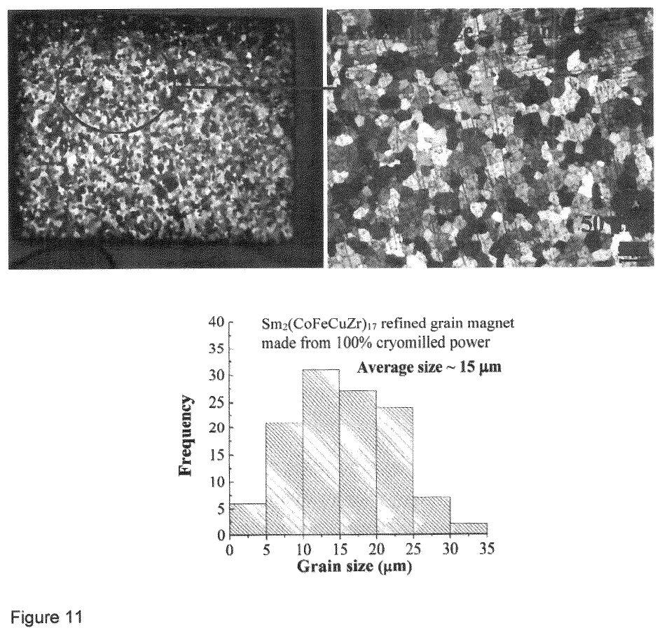

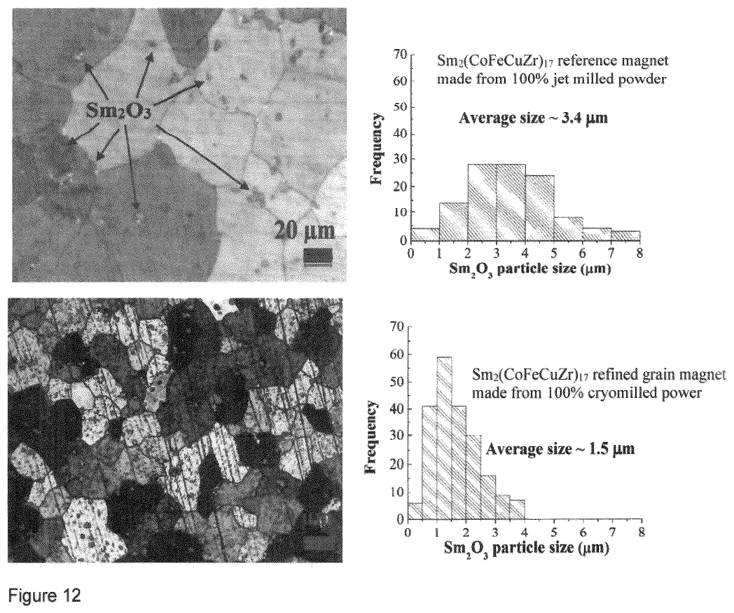

As shown in FIGS. 11 and 12, the average grain size of the Sm₂(CoFeCuZr)₁₇ sintered magnets made from 100 wt. % finer cryomilled feedstock powder was about 15 μm with a refined single-modal grain size microstructure. There were about 0.65 wt. % well-dispersed Sm₂O₃ microparticles with an average particle size of about 1.5 μm in this refined grain magnet. Whereas, the average grain size of the commercial counterpart magnet was about 45 μm. There were about 0.5 wt. % Sm₂O₃ microparticles with an average particle size of about 3.5 μm in the commercial sintered Sm—Co reference magnets while the agglomerates of a few of these Sm₂O₃ microparticles were also commonly observed. A higher volume fraction, a finer average particle size, and better-dispersion of Sm₂O₃ microparticles, which has larger pinning force, lead to finer grain size in the Sm₂(CoFeCuZr)₁₇ sintered magnets made from 100 wt. % finer cryomilled feedstock powder, compare to that of the commercial counterpart magnet. These Sm₂O₃ microparticles mentioned above are “naturally” formed through a partial oxidization during the multi-step magnet fabrication processes, especially during the powder fabrication and handling processes, sintering and heat treatment processes. It should be noticed that, this source of Sm₂O₃ microparticles is different with that of the well-controlled, artificially Sm₂O₃-added magnets, according to an embodiment of the process of the invention. There are two sources of Sm₂O₃ particles in the sintered magnet matrix. One source is the small amount (1 or 3 wt. %) of Sm₂O₃ submicron particles those being artificially added into the magnet matrix, which maintain their original fine particle size in the magnet matrix. The other is the “naturally” formed Sm₂O₃ micron scale particles through a partial oxidization during the magnet fabrication processes which is similar to the non-Sm₂O₃-added magnets.

Further experimental samples were made in accordance with the parameters set forth in the examples described above. These further samples comprised sintered Sm₂(CoFeCuZr)₁₇ that included 0.5 wt. % Sm₂O₃ submicron particles; 2 wt. % Sm₂O₃ submicron particles, and 0.5 wt. % La₂O₃ submicron particles, respectively, (where the Sm₂O₃ particles were 0.35 microns in average particle size and the La₂O₃ particles were 0.2 microns in average particle size). These further samples were tested for mechanical and magnetic properties as described above in the prior examples, and produced similar results in terms of similar mechanical improvements while maintaining their excellent magnetic properties.

For example, the average flexural strength values were enhanced by about 11%, 52%, and 45% (about 127, 173, and 165 MPa) for the Sm₂(CoFeCuZr)₁₇ sintered magnets added with x=0.5 and 2 wt. % of Sm₂O₃, and 0.5 wt. % of La₂O₃ submicron particles, respectively, compared to that of 114 MPa for the reference magnet with x=0. Excellent hard magnetic properties were maintained with (BH)ₘₐₓ values of about 26, 26, 25, and 26 MGOe; Bᵣ values of about 10.6, 10.6, 10.5, and 10.6 kGs; H_{ci} values of about 32.7, 32.5, 34.9, and 35.5 kOe for the Sm₂(CoFeCuZr)₁₇ sintered magnets added with x=0, 0.5, and 2 wt. % Sm₂O₃, and 0.5 wt. % of La₂O₃ submicron particles, respectively.

The magnets made pursuant to embodiments of the invention can be expected to find similar applications in various industries as those of commercial sintered, die-upset or bonded REPMs. Applications include, but are not limited to, e.g., telecommunication, magnetic storage, biomedical equipment, consumer electronics, sensors, power and propulsion applications such as high performance motors and generators and ion engines, inertial devices such as gyroscopes and accelerometers, and traveling wave tubes, and many more.

While exemplary embodiments of the present invention have been shown and described herein, it will be apparent to those skilled in the art that many changes and modifications may be made without departing from the invention in its true scope and broader aspects. The appended claims are therefore intended to cover all such changes and modifications as fall within the spirit and scope of the invention as set forth in the following claims.

Relevant literature references incorporated herein by reference include:
E. P. Wohlfarth, K. H. J. Buschow, Ferromagnetic materials, North Holland, 1988.
http://www.electronenergy.com/products/materials.
J. F. Liu, P. Vora, M. H. Walmer, E. Kottcamp, S. A. Bauser, A. Higgins, and S. Liu, Journal of Applied Physics, 97 (2005) 10H101.
W. Li, A. H. Li, H. J. Wang, W. Pan, H. W. Chang, Journal of Applied Physics, 105 (2009) 07A703.
S. Q. Liu, J. F. Liu, US Patent Pub. No.: US 2005/0081960 A1
X. Y. Li, K. Lu, Nature Materials 16 (2017) 700.
X. L. Wu, M. X. Yang, F. P. Yuan, G. L. Wu, Y. J. Wei, X. X. Huang, and Y. T.
Zhu, Proceedings of the National Academy of Sciences of the United States of America, 112 (2015) 14501.
Y. M. Wang, M. W. Chen, F. H. Zhou, E. Ma, Nature 419 (2002) 912.
P. F. Cesar, H. N. Yoshimura, W. G. Jr Miranda, C. L. Miyazaki, L. M. Muta, L. E. Rodrigues Filho, Journal of Biomedical Materials Research Part B Applied Biomaterials 78 (2006) 265.
L. C. Stearns, M. P. Harmer, Journal of the American Ceramic Society 79 (1996) 3020.
A. V. Karasev, H. Suito, ISIJ International 48 (2000) 658.
Jun Cui, Baozhi Cui, “Feedstock and heterogeneous structure for tough rare earth permanent magnets and production process therefor”, US patent publication No. 2019/0115128 based on U.S. Ser. No. 16/350,215, filed Oct. 15, 2018.

1.-8. (canceled)

9. Feedstock comprising a mixture of rare earth-bearing particles and a percentage of additive particle material wherein the additive particle material includes at least one of metal carbide particle material, metal fluoride particle material, metal nitride particle material, metal oxide particle material, metal sulfide particle material, or combinations of any of these materials.

10. The feedstock of claim 9 wherein morphology of the additive particle material includes at least one of particles, fibers, rods, tubes, dendrites, whiskers, mesoporous structures in either nano-, submicron- and/or micron-scales, or combinations of any of these material morphologies.

11. The feedstock of claim 9 wherein the metal carbide particle material includes at least one of: B—C, Ba—C, Be—C, Al—C, Ca—C, Ce—C, Cr—C, Fe—C, La—C, Li—C, Mo—C, Si—C, TI—O, W—C, Y—C, Zr—C, etc., or a combination of any of these materials; wherein the metal fluoride particle material includes at least one of: Al—F, B—F, Ba—F, Bi—F, Ca—F, Ce—F, Cr—F, Co—F, Cu—F, Dy—F, Fe—F, Hf—F, La—F, Mo—F, Nd—F, Nb—F, P—F, Sm—F, TI—F, V—F,. W—F, Zn—F, Zr—F, or a combination of any of these materials; wherein the metal nitride particle material includes at least one of: Al—N, B—N, Li—N, Cu—N, Fe—N, M—N (M=alkaline-earth metals: Ba, Be Ca, Mg, Sr, Ra), Na—N, Nb—N, P—N, S—N, Ta—N, TIN, W—N, V—N, Y—N, Zn—N, ZrN, or a combination of any of these materials; wherein the metal oxide particle material includes at least one of: Al—O, Ba—O, B—O, Bi—O, Ca—O, Ce—O, Co—O, Cr—O, Cu—O, Dy—O, Er—O, Fe—O, Ga—O, Hf—O, In—O, La—O, Li—O, Mg—O, Mn—O, Mo—O, Na—O, Nd—O, Ni—O, Nb—O, Pr—O, Si—O, Sm—O, Ta—O, TH—O, V—O, W—O. Y—O, Zn—O, Zr—O, or a combination of any of these materials; wherein the metal sulfide particle material includes at least one of: Al—S, Ba—S, Be—S, Bi—S, B—S, Ca—S, Ce—S, Cr—S, Co—S, Cu—S, Dy—S, Er—S, Gd—S, Ga—S, Ge—S, Fe—S, Hf—S, La—S, Li—S, Mg—S, Mn—S, Mo—S, Na—S, No—S, Ni—S, K—S, Pr—S, Sm—S, Si—S, Sn—S, Ti—S, W—S, Y—S, Zn—S, Zr—S, or a combination of any of these materials.

12. The feedstock of claim 12 whose composition is selected for making the rare earth permanent magnet that is selected from R-cobalt type (mainly including RCo₅ and R₂Co₁₇ types, R=rare earth, Lanthanum or Yttrium) magnets R-iron-boron type (R₂Fe₁₄B type or R—TM—B, TM is selected from a group of transition metals consisting essentially of Fe, Co and other transition metal elements) magnets, a R—TM-carbon type magnet (R₂Fe₁₄C type), a R—TM-nitrogen type magnet (R₂Fe₁₇X_{δ}type, R=rare earth, La or Y; X=H, C, N, B, F, P, and/or S), or a, R—TM—M-nitrogen type magnet (R(Fe, M)₁₂X_{δ}type, R=rare earth, La or Y; M=Mo, V, Ti, Si, Al, Cr, Cu, Ga, Ge, Mn, Nb, Sn, Ta, W or Fe; X=H, C, N, B, F, P, and S), and other stable or metastable rare-earth-transition metal based magnetic compounds, having the formula of R₂TM₁₄A, RTM₅, RT₂M₁₇; R₂TM₁₇A, RTM₇, RTM₇A, RTM₁₂, RTM₁₂A, R₃TM₂₉, and R₃TM₂₉A, where in R is one or a combination of rare earths, La or Y, TM is one or a mixture of transition metals, A is one or a combination of the following elements: Be, B, C, N, S, Mg, Al, Si, P, Ga, Ge, As, Se, In, Sn, Sb, Te, I, Pb, and Bi.

13. The feedstock of claim 9 that includes relatively smaller additive particles comprising cryomilled particles made by cryomilling of relatively larger micro-sized jet milled particle powders as precursor particles.

14. The feedstock of claim 9 that includes a mixture comprising relatively smaller additive particles and relatively larger jet-milled particles present in an amount greater than 90% to 99.9% by weight of the mixture.

15. The feedstock of claim 14 wherein the mixture includes relatively smaller cryomilled additive particles.

16. Feedstock comprising fine magnet alloy particle material having an average particle size of 0.1 micron to less than 1.5 microns wherein the magnet alloy particle material comprises 100% of said feedstock.

17. The feedstock of claim 16 wherein the magnet alloy particle material is made by at least one of multiple-cycle jet milling in nitrogen gas, low or high energy ball milling at room temperature in intert gas (Ar, Na, or He) or in solvent media (acetone, ethanol, hexane, heptane, toluene, etc.), surfactant-assisted high energy ball milling at room temperature or immersed in the liquid nitrogen, inert gas atomization, gas condensation, spark erosion, chemical precipitation, sol-gel, pyrolysis and hydrothermal synthesis, thermal decomposition, plasma arcing, chemical reduction or oxidization, gas-solid reaction, vapor-liquid-solid (VLS) process, carburizing, carbonitriding, nitriding, chemical vapor deposition (CVD), physical vapor deposition (PVD), hydrogen decrepitation (HD), hydrogen decrepitation deabsorbation recombination (HDDR) process, severe plastic deformation (SPD), electrodeposition, colloidal lithography, or atomic layer deposition (ALD).

18.-20. (canceled)
